(19) United States
(12) Patent Application Publication
(10) Pub. No.: US 2016/0212077 A1
(43) Pub. Date: Jul. 21, 2016

(54) METHODS AND SYSTEMS FOR PROCESSING INFORMATION IN A NETWORK

(71) Applicant: KUO-CHUN FANG, Inglewood, CA (US)

(72) Inventor: KUO-CHUN FANG, Inglewood, CA (US)

(21) Appl. No.: 14/931,889

(22) Filed: Nov. 4, 2015

Related U.S. Application Data
(63) Continuation-in-part of application No. 14/748,533, filed on Jun. 24, 2015.
Application No. 14/748,533 is a continuation-in-part of application No. 14/721,001, filed on May 26, 2015.
(60) Provisional application No. 62/105,314, filed on Jan. 20, 2015.
(60) Provisional application No. 62/111,223, filed on Feb. 3, 2015.

(51) Int. Cl. H04L 12/58; H04L 29/12; H04L 29/08; H04L 12/24

(52) U.S. Cl. CPC H04L 51/10; H04L 41/12; H04L 61/2007; H04L 67/18; H04L 61/6059

(57) ABSTRACT

Methods and systems for presenting information on a computing device in a network are disclosed. The method includes registering the computing device with the network based on registration information entered by a user. The method also includes authenticating the computing device based on login credential information. The method further includes connecting the computing device to the network based on the authentication. The method also includes receiving one or more messages comprising at least one hashtag from one or more network devices based on a predefined preference of the user. The network devices are connected to and registered with the network. The network devices are within a predefined range of distance of the computing device. The method also includes presenting the one or more messages on the computing device.

### FIELD OF THE INVENTION

The present invention generally relates to techniques for online processing and display of information in a network. Particularly, the present subject matter relates to methods and systems for presenting information on a computing device of a user based on predefined preferences of a user, wherein the computing device is connected to a network. The systems and methods may also present the information based on hashtags.

### BACKGROUND OF THE INVENTION

With an ever-increasing data and information on the Internet, finding relevant information has become a daunting task. To add to this, the enthusiasm of people to capture every moment of their lives and upload the same on social media networks has made this web of information even more tangled and complex. Constant updating of status, images, locations, activities etc. provides the millions of social media users an opportunity to showcase the social and other aspect of their lives. Amidst this social networking frenzy, a trend that has caught the fancy of users is that of tagging their pictures, data, location and other information to ensure that their data becomes a part of a specific theme based pool of information that can be easily showcased or retrieved at a later time by using the specific tags. One such common tagging mechanism is adding liashtags' to any data uploaded on social media.

A hashtag may be a metadata tag or label added to any data posted on social media networks to ensure that users searching for information related to a specific theme or field easily find the data. For example, the hashtag “#YummyItalian” added to a picture of friends at an Italian restaurant showcases visit to an Italian restaurant and the friends' view that the food at the restaurant is great! All that a user needs in order to promptly upload data on social media platforms is a user device such as a smart phone, tablet etc. and a wireless access device such as a wireless router that enables the user device to wirelessly connect to the Internet. Widespread usage of wireless access devices at public and commercial places has become a boon for social networking users to constantly post and tag data on social networking platforms.

Though a great way to sort and access data posted on social media, hashtags and other tagging mechanisms have also resulted in a lot of wrong and redundant categorization of social media data. This is because either user does not know the correct manner of tagging social media data posted by them or lot of non-uniform and random tags are used. For example, for photographs of two different groups of friends dining at the same restaurant, one photograph is tagged “#YummyItalian” while the other is tagged “#AwesomeFood”. Now a user looking for good Italian food online will be able to access the first photograph but not the second due to usage of an overly generic tag. Moreover, in both the instances, the restaurant owner does not benefit in any way as the restaurant is not identified in any of the tags and the owner has to rely on the users' discretion of disclosing the location of dining or the name of the restaurant.

Further, wireless Internet or WiFi network is almost everywhere these days, for example in hospitals, shops, beauty salons, restaurants, and so forth. Every wireless modem or device broadcasts a SSID or UID. The SSID and UID are visible to all the computing devices that can scan or detect the WiFi network, but only on authorization. The user may connect his/her devices to the WiFi network based on authorization.

### SUMMARY

In today's world where sorting the pool of information and data available on social media has become essential for enabling meaningful access and utilization of such data, techniques are needed that helps the users to appropriately tag the social media data being uploaded. Hashtag may also have commercial utility. For example, when a user connects to a network or enters a new network the user may be provided with advertisements or information about nearby restaurants, shops, malls, etc. based on the Also, there is a great need of a method that helps the businesses take advantage of this tagging done by social network users. The systems and methods may also enable users to search, save, manage, and track multimedia messages over various social media platforms or websites corresponding to hashtags.

The present disclosure provides systems and methods for improved techniques for processing information on a computing device in a network.

The present disclosure finds particular application in managing and displaying information through various networks, specifically wireless networks, on the computing devices in a network, and will be described with particular reference thereto. However, it is to be appreciated that the present disclosure is also amenable to other like applications.

In one implementation, methods, systems, and computer program products are provided for processing of information and presenting of information on a computing device in a network. The method may include registering, by a registration device, the computing device with the network based on a registration information entered by a user. The method may also include authenticating, by an authentication device, the computing device based on a login credential information. The method may further include connecting, by a connection managing device, the computing device to the network based on the authentication. The method may also include receiving, by a transceiving device, one or more messages comprising at least one hashtag from one or more network devices based on a predefined preference of the user. The network devices are connected to and registered with the network. In some embodiments, the network devices may be registered with the information processing device. The network devices may be present within a predefined range of distance of the computing device. The method may also include presenting, by a message managing device, the one or more messages on the computing device.

In one implementation, a computer program product including program instructions tangibly stored on a computer-readable medium and operable to cause a computer system to perform a method is provided. The computer program product stores the instruction for presenting information at a computing device in a network. The CPP also includes instructions for registering the computing device with the network based on a registration information entered by a user. The CPP also includes instructions for authenticating the computing device based on a login credential information. The CPP also includes instructions for connecting the computing device to the network based on the authentication. The CPP also includes instructions for receiving one or more messages comprising at least one hashtag from one or more network devices based on a predefined preference of the user. The network devices are connected to and registered with the network. The network devices are within a predefined range of distance of the computing device. The CPP also includes instructions for presenting the one or more messages on the computing device.

In other implementations, the computing device used can be any device which can perform calculations and can be used for receiving and displaying messages by connecting to a network. The computing device without any limitation includes devices like phones, tablet computers, computers, mobile devices, smart phones, and laptops.

An embodiment of the present disclosure provides a system for presenting information on a computing device in a network. The system may include a registration device configure to register the computing device with the network based on a registration information provided by the user at the computing device. The system may also include an authentication device configured to authenticate the computing device based on a login credential information. The system may also include a connection managing device configured to connect the computing device to the network based on the authentication. The system may further include a storage device configured to store information about the user, the computing device, the network devices, predefined preferences of the user, registration information, and login credential information. The system may also include a transceiving device configured to receive one or more messages comprising at least one hashtag based on a predefined preference of the user from the one or more network devices. The one or more network devices may be connected to and registered with the network. The one or more network devices are present within a predefined range of distance of the computing device. The system may also include a message managing device configured to present the one or more messages on the computing device.

Another embodiment of the present disclosure provides an online information processing system including a registration device, an authentication device, a connection managing device, a transceiving device, a message managing device, a storage device. The registration device may be configured to register the computing device associated with a user with at least one of a network and the online information processing system based on a registration information provided by the user. The authentication device may be configured to authenticate the computing device based on a login credential information. The connection managing device may be configured to connect the computing device to the network based on the authentication. The storage device may be configured to store information about the user, the computing device, the network devices, predefined preferences of the user, registration information, and login credential information. The transceiving device may be configured to receive one or more messages comprising at least one hashtag based on a predefined preference of the user from the one or more network devices. The one or more network devices may be connected to and registered with the network. The one or more network devices may be present within a predefined range of distance of the computing device. The message managing device configured to present the one or more messages on the computing device based on a unique identifier assigned to the computing device.

Another embodiment of the present disclosure provides an information processing system or device for processing information in a wireless network. The system may include a registration device configured to register a computing device associated with a user with the network based on a registration information entered by the user. The system may also include an authentication device configured to authenticate the computing device based on a login credential information. The system may also include a connection managing device configured to assign a unique identifier to the computing device, wherein the unique identifier comprises an Internet Protocol version 6 (IPv6) address. The connection managing device may also be configured to connect the computing device to the network based on the authentication. The storage device may be configured to store information about the user information about the computing device, the network devices, predefined preferences of the user, the registration information, and the login credential information. The system may also include a transceiving device configured to receive one or more messages comprising at least one hashtag based on a predefined preference of the user from the one or more network devices, wherein the one or more network devices being connected to and registered with the network, wherein the one or more network devices are present within a predefined range of distance of the computing device. The system may also include a message managing device configured to present the one or more messages on the computing device based on a unique identifier assigned to the computing device.

Other and further aspects and features of the disclosure will be evident from reading the following detailed description of the embodiments, which are intended to illustrate, not limit, the present disclosure.

### BRIEF DESCRIPTION OF THE DRAWINGS

The illustrated embodiments of the disclosed subject matter will be best understood by reference to the drawings, wherein like parts are designated by like numerals throughout. The following description is intended only by way of example, and simply illustrates certain selected embodiments of devices, systems, and processes that are consistent with the disclosed subject matter as claimed herein.

FIG. 1A is a schematic diagram illustrating an exemplary environment, where various embodiments of the present disclosure may function;

FIG. 1B is another schematic diagram illustrating another exemplary environment, where various embodiments of the present disclosure may function;

FIG. 2 is a block diagram illustrating various system elements of an exemplary information processing device, in accordance with an embodiment of the present disclosure;

FIG. 3 is a flowchart illustrating an exemplary method for presenting information on a computing device, in accordance with an embodiment of the present disclosure; and

FIG. 4 is a flowchart illustrating another exemplary method for presenting information on a computing device, in accordance with another embodiment of the present disclosure.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

The functional units described in this specification have been labeled as systems or devices. A device or a system may be implemented in programmable hardware devices such as processors, digital signal processors, central processing units, field programmable gate arrays, programmable array logic, programmable logic devices, cloud processing systems, or the like. The devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable of an identified device need not be physically located together, but may comprise disparate instructions stored in different locations which, when joined logically together, comprise the device and achieve the stated purpose of the device.

Indeed, an executable code of a device could be a single instruction, or many instructions, and may even be distributed over several different code segments, among different applications, and across several memory devices. Similarly, operational data may be identified and illustrated herein within the device, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the disclosed subject matter. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

### Non-Limiting Definitions

In various embodiments of the present disclosure, definitions of one or more terms that will be used in the document are provided below.

As used herein, a “computing device” as used herein includes a single device capable of communicating, and exchanging one or messages with other devices present in a network. The computing device is also configured to connect to the network such as the Internet.

As used herein, a “Graphical User Interface” (GUI) can include an interface on a display device of the computing device enabling a user to interact with the device or computing device.

As used herein, a “social media website” refers websites that may allow people to create, share or exchange information, ideas, and pictures/videos in a virtual community or virtual social network.

Further, a “computing device” can include a single device or multiple devices, which may be configured to automatically tag data or data of various images and the data/data posted on various social media websites, and combination of any of these.

As used herein, an “information processing device” refers to a device including a software, hardware or combination of these, that is configured to manage information in a network based on hashtags.

Further, as used herein, a “registration device” refers to a device including hardware, software, firmware, or combination of these that can be configured to register various computing devices with network(s).

Further, as used herein, a “transceiving device” refers to a device including hardware, software, firmware, or combination of these that can be configured to send and receive information or messages in a network.

Further, as used herein, a “storage device” refers to a device including hardware, software, firmware, or combination of these that can be configured to store the one or more multimedia messages, information about various users, computing devices, network devices, user preferences, and a plurality of hashtags.

Further, as used herein, a “connection managing device” refers to a device including hardware, software, firmware, or combination of these that can be configured to manage connection between computing devices and networks.

Further, as used herein, an “authentication device” refers to a device including hardware, software, firmware, or combination of these. Further, the authentication device can authenticate the computing devices.

Further, as used herein, a “transceiving device” is a device configured to transmit or receive data, files, multimedia messages, images, and other information to and from network devices in the network. The transceiving device can include hardware, software, firmware, and combination of these.

As used herein, a “multimedia message” refers to a message including text, image, video, audio, hyperlink, hashtag, and combination of these.

As used herein, a “message managing device” refers to a device comprising hardware, software, firmware, and combination of these. The message managing device can manage presentation of one or more messages on various computing devices in the network.

As used herein, an “Internet Protocol version 6 (IPv6) address” refers to a numerical address or identifier that may be used to identify a network interface of a computing device or a network device in an IP version 6 network. The IPv6 address may uniquely identify the computing device or the network device in the network or the IPv6 network.

The device or system for processing of information in a network may be a software, hardware, firmware, or combination of these. The device or the system is further intended to include or otherwise cover all software or computer programs capable of performing the various heretofore-disclosed determinations, calculations, etc., for the disclosed purposes. For example, exemplary embodiments are intended to cover all software or computer programs capable of enabling processors to implement the disclosed processes. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed below.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

Some of the disclosed embodiments include or otherwise involve data transfer over a network, such as communicating various inputs or files over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. The network may include multiple networks or sub networks, each of which may include, for example, a wired or wireless data pathway. The network may include a circuit-switched voice network, a packet-switched data network, or any other network able to carry electronic communications. For example, the network may include networks based on the Internet protocol (IP) or asynchronous transfer mode (ATM), and may support voice using, for example, VoIP, Voice-over-ATM, or other comparable protocols used for voice data communications. In one implementation, the network includes a cellular telephone network configured to enable exchange of text or SMS messages.

Examples of the network include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth.

### Exemplary Embodiments

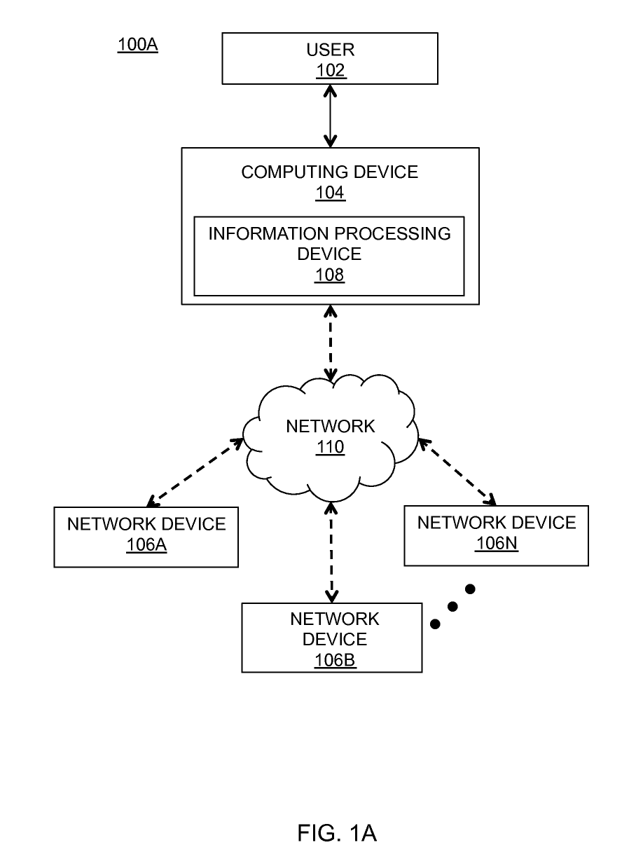

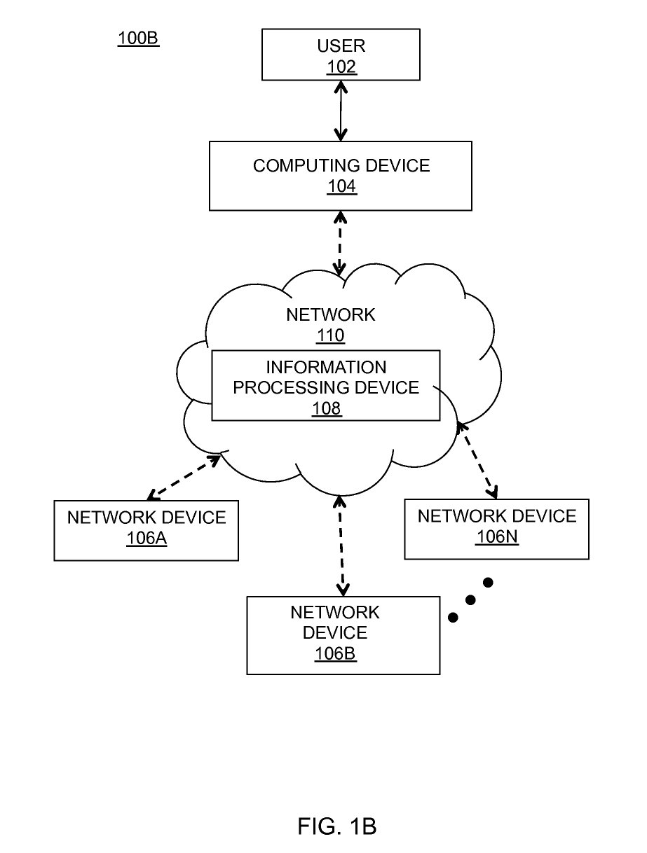

FIG. 1A is a schematic diagram illustrating an exemplary environment 100A, where various embodiments of the present disclosure may function. As shown, the environment 100A may include a computing device 104 associated with a user 102. The computing device 104 may be any computation device capable of connecting with a network 110 and communicating with other devices connected to the network 110. The network 110 may be a wired network, a wireless network or combination of these. In some embodiments, the network 110 is an Internet Protocol version 6 (IPv6) network.

Examples of the computing device 104 may include, such as, but are not limited to, a mobile phone, a desktop computer, a laptop computer, a smart phone, a personal digital assistant (PDA), a tablet computer, a smart television, a television, and so forth. The computing device 104 may include an associated display device. The computing device 104 may also include an information processing device 108 configured to process and present information on the computing device 104. The user 102 may access a browsing application such as, but not limited to, Google Chrome, Internet Explorer, Mozilla Firefox, and so forth on the computing device 104. Further, the user 102 may register the computing device 104 with the network 110 by entering or providing registration information at the computing device 104. The user 102 via the computing device 104 may be configured to access the network 110 by entering or providing login credential information including, such as, but are not limited to, name, identifier, password, e-mail identifier, and so forth. The information processing device (or system) may authenticate the computing device 104 (or the user 102) based on the login credential information. Post authentication, the computing device 104 may be connected to the network 110. In some embodiments, the information processing device 108 may be configured to connect the computing device 104 to the network 110. In some embodiments, the information processing device 108 may assign a unique identifier to the computing device 104. In some embodiments, the unique identifier may include an IPv6 address. The information processing device 108 may be configured to receive one or more inputs from the user 102. The inputs may be keywords, identifiers, hashtags, personal information of the user, and so forth. The information processing device 108 may be configured to receive the predefined preferences from the user 102.

Further, the user 102 may also access a website such as a social media website on the computing device through the browsing application. Examples of the social media website may include, but are not limited to, Instagram™, Facebook™, Twitter™, LinkedIn™, and so forth.

The information processing device 108 may also store and maintain information about the user 102, the computing device 104, the network devices, predefined preferences of the user 102, registration information, login credential information, and so forth. The information processing device 108 may be configured to manage and display information to the user 102 based on identifier or hashtag entered by the user 102.

In an implementation, placement or display of messages or multimedia messages on the computing device 104 may also depend on paid services taken or subscribed by the user 102. For example, if the user 102 has paid a fee for displaying messages from Chinese restaurants than whenever the user 102 connects with the network 110, the computing device 104 receives the messages from the Chinese restaurants nearby. The display of the messages on the computing device may also be based on predefined preferences of the user 102. The predefined preferences may be preferences about location, time duration, type of messages, IPv6 address, and so forth. Examples of the predefined preferences may include, during 1 PM to 4 PM messages for restaurants should be displayed at the computing device 104, messages of shops or restaurants that are within 5 kilometers (km) only should be displayed, and so forth. The messages may be sent by a number of network devices 106A-106N that may be registered with the network 110 or with the information processing device 108. Examples of the network devices 106A-106N may be computation devices present in the network 110. The network devices 106A-106N may be associated with entities like restaurants, shops, hospitals, schools, beauty salons, and so forth.

Further, the messages may include advertisements, information about these entities. In some embodiments, the messages may include hashtags, hyperlinks, audio, video, text, and combination of these. Further, an order of the messages may be defined or determined by the information processing device 108 based on the fees paid by the entities. For example, an entity associated with one of the network devices 106A-106N may avail paid services of the information processing device 108 for displaying their associated message or advertisement first in the predefined order. Also, the entity may choose to display their multimedia message at a first position in the predefined order whenever a particular condition is met. For example, a condition may be time, location, and so forth. For example, the entity may choose to display or present its message at a first position at 2 PM-3 PM daily.

Further, each of the messages may include a hyperlink for allowing the user 102 to browse to a source website associated with each of the one or more multimedia messages. The source website may be a website or a social media website from where the multimedia message is retrieved so when the user 102 clicks on one of the messages, then the browsing application may direct the user 102 to the source website from where the message is picked or retrieved by the information processing device 108. In some embodiments, at least five multimedia messages are displayed at the computing device in form of a ring or webring. The ring or webring may be a collection of websites or messages that are inked together in a circular structure, and may be arranged around a same theme. The information processing device 108 may allow the user 102 to set or update his/her preferences in real time.

The information processing device 108 may also be configured to register the computing device 104 or the network devices 106A-106N by receiving information from the user 102 or second users of the network devices 106A-106N. The registration information may include a name, a login identifier, a password, an email address or ID, time zone, location, address, an age of the user 102, payment details, and so forth. The registered user may subscribe for messages. The user 102 may access one or more features of the information processing device or system 108 based on the subscription. The user 102 may be allowed to upgrade or downgrade their subscription at a later stage. In some embodiments, the user 102 may enter registration information at the computing device 104.

In some embodiments, the information processing device or system 108 may be present on a remote device located in the network 110. FIG. 1B is another schematic diagram illustrating another exemplary environment 100B, where various embodiments of the present disclosure may function. As shown, the information processing device 108 is a separate device and may be located remotely from the computing device 104. The user 102 may access the information processing device 108 via any suitable browsing application when connected to the network 110. The user 102 may enter the information like registration information, the identifier, and the hashtag at the computing device 104. The computing device 104 may be configured to communicate with the information processing device 108 by sending and receiving messages or information over the network 110.

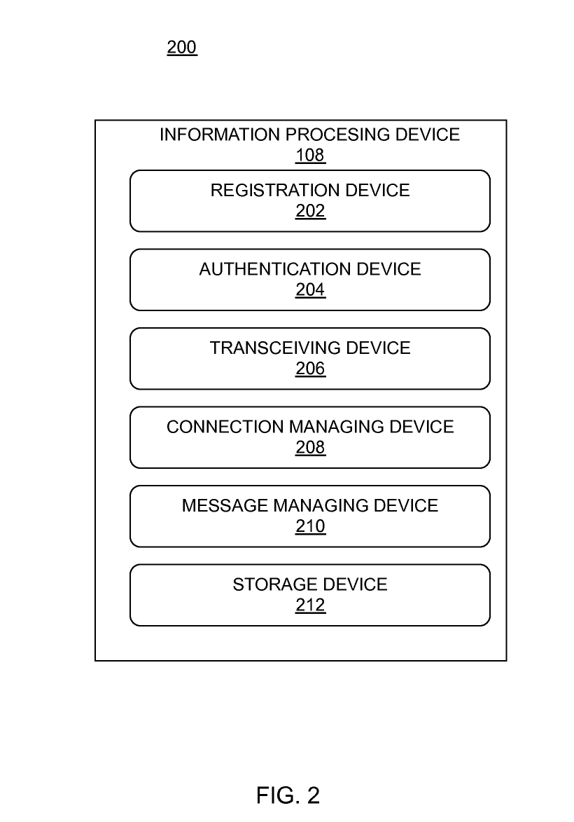

FIG. 2 is a block diagram 200 illustrating various system elements of an exemplary information processing device 108 of FIGS. 1A-1B, in accordance with an embodiment of the present disclosure. As shown, the information processing device 108 may primarily include a registration device 202, an authentication device 204, a transceiving device 206, a connection managing device 208, a message managing device 210, and a storage device 212. The information processing device 108 may be located within the computing device 104 as shown in FIG. 1A or may be located remotely in the network 110 as shown in FIG. 1B.

The information processing device 108 may be configured to present information on the computing device 104. The information may include one or more messages. The messages may include such as, but not limiting to, text message, The interface may be a graphical user interface including at least one search field as discussed with reference to FIGS. 1A-1B. The user 102 can enter one or more inputs or information at the computing device 104. In some embodiments, the user 102 may enter an identifier, such as at least one hashtag, in the search field.

The registration device 202 may be configured to register the computing device 104 with the network 110 based on a registration information entered by the user 102 at the computing device 104. The registration information may include, such as, but not limited to, a name, an e-mail ID, an age, an address, and so forth. In some embodiments, the registration device 202 may be configured to register the computing device 104 with the information processing system or device 108 (or online information processing system or device 108).

The authentication device 204 may be configured to authenticate the computing device 104 based on login credential information entered by the user 102. The authentication device 204 may compare the entered login credential with login credential stored in the storage device 212.

The connection managing device 208 may be configured to assign a unique identifier to the computing device 104. The unique identifier may include an IPv6 address. The connection managing device 208 may also be configured to establish a connection of the computing device 104 with the network 110 based on the authentication.

The transceiving device 206 may be configured to receive one or more messages from one or more of the network devices 106A-106N. The network devices 106A-106N may be connected to the network 110. In some embodiments, the network devices 106A-106N may be registered with the network 110. In alternate embodiments, the network devices 106A-106N may be registered with the information processing device 108. Further, the one or more messages may be received from one or more network devices based on a predefined preference of the user 102. The predefined preference may include a time duration, location category, type of messages, and distance related preferences of the user 102 of the computing device 104.

The message managing device 210 may be configured to present the received one or more messages on the computing device 104. The messages may include text, hyperlink, hashtag, audio, video, and so forth. In some embodiments, the messages may be displayed at a display of the computing device 104. In some embodiments, the messages may be presented based on a subscription by the user 102 for the messages. In further embodiments, the messages may be presented based on a location of the computing device 104. In alternative embodiments, the messages may be presented based on a time of the day.

Further, the storage device 212 may store, the registration information, the login credential information, the information about the network devices 106A-106N, the network addresses, a number of messages, unique identifier of the computing device 104, information about the user 102, information about the computing device 104, predefined preferences of the user 102, and so forth. The login credential information may include, such as, but not limited to, a login ID, a password, an e-mail ID, and so forth. The transceiving device 206 may be configured to receive the inputs or information from the computing device 104. In some embodiments, the at least one hashtag is received from the computing device 104. The user 102 may enter more than one hashtag in the search field.

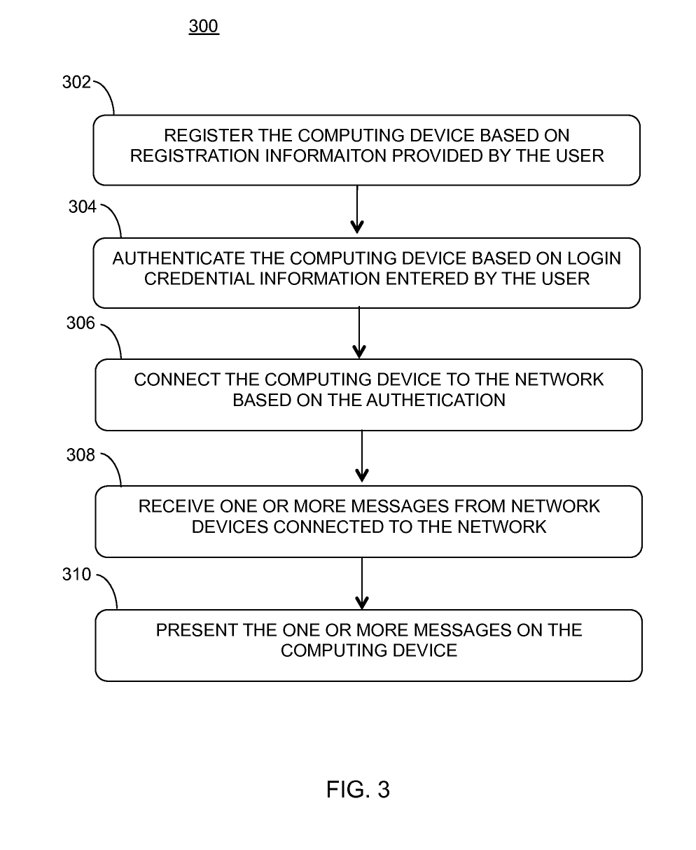

FIG. 3 is a flowchart illustrating an exemplary method 300 for presenting information on a computing device such as the computing device 104 of FIGS. 1A-1B, in accordance with an embodiment of the present disclosure. As discussed with reference to FIGS. 1A-1B, the user 102 (or first user 102) may register the computing device 104 with the network 110 or the information processing device 108 by entering registration information at the computing device 104. In some embodiments, the user 102 may be required to provide information in a specific format. For example, information should be prefixed with a symbol, such as, but not limited to hashtag. The computing device 104 may include an associated display device (not shown). The user 102 may interact with the computing device 104 via one or more interfaces. The information processing device 108 may be configured to be part of the computing device 104 or may be located remotely from the computing device 104 in the network 110. Further, as discussed with reference to FIG. 2, the information processing device 108 may include the registration device 202, the authentication device 204, the transceiving device 206, the connection managing device 208, the message managing device 210, and the storage device 212.

At step 302, the computing device 104 may be registered based on the registration information provided by the user 102. In some embodiments, the computing device 104 may be registered with the network 110. In some embodiments, the registration device 202 registers the computing device 104 with the network 110 or the information processing device 108. In alternative embodiments, the user 102 may be registered with the information processing device 108. The registration information may include such as, but not limited to, a name of the user, an age, an address, an e-mail ID, and so forth. Further, while registration the user 102 may subscribe for receiving different types of messages. Further, the user 102 may define preferences at the time of registration. The preferences may be location related, time related, IP address related, category of network devices related, and so forth. For example, the user 102 may specify a time duration, during which the user 102 may want to receive messages on the computing device 104 or may want the messages to be presented at the computing device 104. In another exemplary scenario, the user 102 may specify location or area and also type of vendors from whom the messages should be received. For example, if the user 102 specifies to receive messages from the restaurants present within a distance of 5 kilometers then the computing device 104 may receive messages from the restaurants present within the 5 KM of area.

At step 304, the computing device 104 may be authenticated based on login credential information entered by the user 102 at the computing device 104. The login credential information may include a name, e-mail ID, login ID, a network ID, a password, and so forth. In some embodiments, the authentication device 204 authenticates the computing device 104. Further, the authentication device 204 may authenticate the computing device 104 by comparing the entered login credential information with pre-stored login credential information of the storage device 212.

At step 306, the computing device 104 may be connected to the network 110 based on the authentication. In some embodiments, the connection managing device 208 may connect the computing device 104 to the network 110. Then at step 308, the computing device 104 receives one or more messages from one or more network devices connected to the network 110. In some embodiment, the transceiving device 206 receives the messages from the network devices 106A-106N. In alternative embodiments, when the information processing device 108 is located remotely, then the transceiving device 206 forwards the messages to the computing device 104.

Thereafter, at step 310, the one or more messages may be presented on the computing device 104. In some embodiments, the message managing device 210 presents the messages on the computing device 104. The messages may be presented on a display device associated with the computing device 104.

In some implementations, placement or display of messages on the display device of the computing device 104 may depend on paid services taken or subscribed by the user 102. For example, if the user 102 has paid a fee for receiving messages of beauty salons, movie halls, etc. then the advertisements, messages of the beauty salons, movie halls are displayed at the computing device 104.

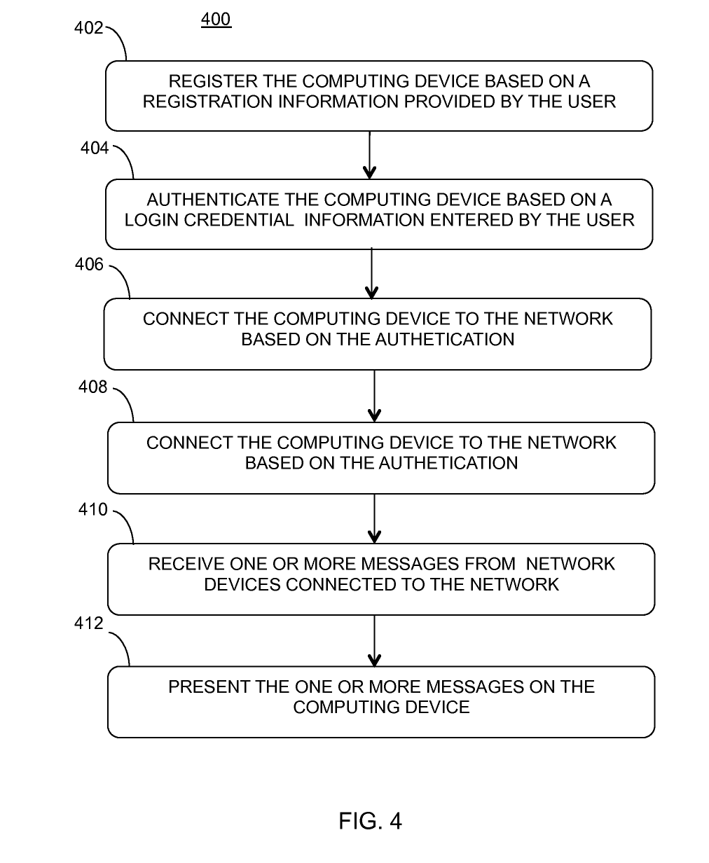

FIG. 4 is a flowchart illustrating an exemplary method 400 for presenting messages on the computing device 104, in accordance with another embodiment of the present disclosure. As discussed with reference to FIGS. 1A-1B, the user 102 (or first user 102) may register the computing device 104 with the network 110 or the information processing device 108 by entering registration information at the computing device 104. In some embodiments, the user 102 may be required to provide information in a specific format. For example, information should be prefixed with a symbol, such as, but not limited to hashtag. The computing device 104 may include an associated display device (not shown). The user 102 may interact with the computing device 104 via one or more interfaces. The information processing device 108 may be configured to be part of the computing device 104 or may be located remotely from the computing device 104 in the network 110. Further, as discussed with reference to FIG. 2, the information processing device 108 may include the registration device 202, the authentication device 204, the transceiving device 206, the connection managing device 208, the message managing device 210, and the storage device 212.

At step 402, the computing device 104 may be registered based on the registration information provided by the user 102. In some embodiments, the computing device 104 may be registered with the network 110. In some embodiments, the registration device 202 registers the computing device 104 with the network 110 or the information processing device 108. In alternative embodiments, the user 102 may be registered with the information processing device 108. The registration information may include such as, but not limited to, a name of the user, an age, an address, an e-mail ID, and so forth. Further, while registration the user 102 may subscribe for receiving different types of messages. Further, the user 102 may define preferences at the time of registration. The preferences may be location related, time related, IP address related, category of network devices related, and so forth. For example, the user 102 may specify a time duration, during which the user 102 may want to receive messages on the computing device 104 or may want the messages to be presented at the computing device 104. In another exemplary scenario, the user 102 may specify location or area and also type of vendors from whom the messages should be received. For example, if the user 102 specifies to receive messages from the restaurants present within a distance of 5 kilometers then the computing device 104 may receive messages from the restaurants present within the 5 KM of area.

At step 404, the computing device 104 may be authenticated based on login credential information entered by the user 102 at the computing device 104. The login credential information may include a name, e-mail ID, login ID, a network ID, a password, and so forth. In some embodiments, the authentication device 204 authenticates the computing device 104. Further, the authentication device 204 may authenticate the computing device 104 by comparing the entered login credential information with pre-stored login credential information of the storage device 212.

At step 406, a unique identifier is assigned to the computing device 104 post authentication. The unique identifier may be an IPv6 address and may uniquely identify the computing device 104 in the network 110. In some embodiments, the connection managing device assigns the unique identifier to the computing device 104.

Then at step 408, the computing device 104 may be connected to the network 110 based on the authentication. In some embodiments, the connection managing device 208 may connect the computing device 104 to the network 110. Then at step 410, the computing device 104 receives one or more messages from one or more network devices connected to the network 110. The one or more messages may include a hashtag, a video message, an audio message, a text message, and combination of these. In some embodiment, the transceiving device 206 receives the messages from the network devices 106A-106N. In alternative embodiments, when the information processing device 108 is located remotely, then the transceiving device 206 forwards the messages to the computing device 104. The messages may be received based on the subscription or predefined preferences of the user 102 or the computing device 104.

Thereafter, at step 412, the one or more messages may be presented on the computing device 104. In some embodiments, the message managing device 210 presents the messages on the computing device 104. The messages may be presented on a display device associated with the computing device 104.

In some implementations, placement or display of messages on the display device of the computing device 104 may depend on paid services taken or subscribed by the user 102. For example, if the user 102 has paid a fee for receiving messages of beauty salons, movie halls, etc. then the advertisements, messages of the beauty salons, movie halls are displayed at the computing device 104.

A computer program product including program instructions tangibly stored on a computer-readable medium and operable to cause a computer system to perform the method disclosed herein may be an application software that enables a computing device to capture unique strings included within identifiers being broadcasted by a wireless access device. The unique identifier may be an SSID. The application program may further provide an interface that permits the user to choose and attach specific unique strings to the content being posted on social media. In an alternate embodiment the application software may be configured to automatically post content on pre designated social media platforms along with the chosen unique strings attached to such content.

It will be understood that the devices and the databases referred to in the previous sections are not necessarily utilized together method or system of the embodiments. Rather, these devices are merely exemplary of the various devices that may be implemented within a computing device or the server device, and can be implemented in exemplary another devices, and other devices as appropriate, that can communicate via a network to the exemplary server device.

It will be appreciated that several of the above-disclosed and other features and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

The terminology used herein is for the purpose of describing particular embodiments only and is not intended to be limiting of the disclosure. It will be appreciated that several of the above disclosed and other features and functions, or alternatives thereof, may be combined into other systems, methods, or applications. Various presently unforeseen or unanticipated alternatives, modifications, variations, or improvements therein may subsequently be made by those skilled in the art without departing from the scope of the present disclosure as encompassed by the following claims.

What is claimed is:

1. A method for presenting information, the method comprising:
detecting, by a detection device, a hotspot device present within a predefined range of area, wherein the hotspot device is configured to interconnect a plurality of computing devices and a plurality of network devices;
connecting, by a connection managing device, at least one computing device of a plurality of computing devices to the hotspot device based on an authentication of the computing device;
receiving, by a transceiving device, one or more messages comprising at least one hashtag from the one or more of the plurality of network devices connected to the hotspot device, wherein the one or more messages being received based on a predefined preference of a user of the at least one computing device; and
presenting, by a message managing device, the one or more messages on the at least one computing device based on a unique identifier assigned to the computing device, wherein the hotspot device assigns the unique identifier to the at least one computing device.

2. The method of claim 1 wherein the unique address is an Internet Protocol version 6 (IPv6) address.

3. The method of claim 2 further comprising presenting the one or more messages on the computing based on a subscription by the user for the messages.

4. The method of claim 3 further comprising presenting the one or more messages on the computing based on a location of the computing device.

5. The method of claim 4 further comprising presenting the one or more messages on the computing based on a predefined time.

6. The method of claim 5, wherein the one or more messages comprises at least one of a text message, an audio message, a hyperlink, and a video message.

7. The method of claim 6, wherein the predefined preference comprises a time duration, a location category, type of messages, and a distance related preferences of the user of the computing device.

8. The method of claim 7, wherein the hotspot device is at least one of the plurality of computing devices and the plurality of network devices.

9. An information processing system comprising:
a detection device configured to detect a hotspot device, wherein the hotspot device is configured to interconnect a plurality of computing devices and a plurality of network devices;
a connection managing device configured to connect at least one computing device of a plurality of computing devices to the hotspot device based on an authentication of the computing device;
a transceiving device configured to receive one or more messages comprising at least one hashtag from the one or more of the plurality if network devices connected to the hotspot device, wherein the one or more messages being received based on a predefined preference of a user of the at least one computing device; and
a message managing device configured to present the one or more messages on the at least one computing device based on a unique identifier assigned to the computing device, wherein the hotspot device assigns the unique identifier to the at least one computing device.

10. The system of claim 9, wherein the connection managing device is further configured to assign a unique identifier to the computing device, wherein the unique address comprises an Internet Protocol version 6 (IPv6) address.

11. The system of claim 10, wherein the message managing device is also configured to display the one or more messages on the computing based on a subscription of the user.

12. The system of claim 11, wherein the message managing device is also configured to present the one or more messages on the computing based on a location of the computing device.

13. The system of claim 12, wherein the message managing device is also configured to present the one or more messages on the computing based on a predefined time.

14. The system of claim 13, wherein the message managing device is further configured to present the one or more messages on the computing device based on the unique identifier assigned to the computing device.

15. The system of claim 14, wherein the one or more messages comprises at least one of a text message, an audio message, a hyperlink, and a video message.

16. The system of claim 15, wherein the predefined preference comprises time duration, location category, type of messages, and distance related preferences of the user of the computing device.

17. The system of claim 16, wherein the network comprises wireless network.

18. The system of claim 17, wherein the hotspot device is at least one of the plurality of computing devices and the plurality of network devices.

19. A method for presenting information, the method comprising:
detecting, by a detection device, a hotspot device present within a predefined range of area, wherein the hotspot device is configured to interconnect a plurality of computing devices and a plurality of network devices with each other, further wherein the hotspot device is at least one of the plurality of computing devices and the plurality of network devices;
connecting, by a connection managing device, at least one computing device of a plurality of computing devices to the hotspot device based on an authentication of the computing device;
receiving, by a transceiving device, one or more messages comprising at least one hashtag from the one or more of the plurality of network devices connected to the hotspot device, wherein the one or more messages being received based on a predefined preference of a user of the at least one computing device; and
presenting, by a message managing device, the one or more messages on the at least one computing device based on a unique identifier assigned to the computing device, wherein the hotspot device assigns the unique identifier to the at least one computing device, further wherein the unique identifier comprising an Internet Protocol version 6 (IPv6) address.

20. An information presenting system comprising:
a detection device configured to detect a hotspot device, wherein the hotspot device is configured to interconnect a plurality of computing devices and a plurality of network devices with each other further wherein the hotspot device is at least one of the plurality of computing devices and the plurality of network devices;
a connection managing device configured to connect at least one computing device of a plurality of computing devices to the hotspot device based on an authentication of the computing device;
a transceiving device configured to receive one or more messages comprising at least one hashtag from the one or more of the plurality if network devices connected to the hotspot device, wherein the one or more messages being received based on a predefined preference of a user of the at least one computing device; and
a message managing device configured to present the one or more messages on the at least one computing device based on a unique identifier assigned to the computing device, wherein the hotspot device assigns the unique identifier to the at least one computing device, further wherein the unique identifier comprising an Internet Protocol version 6 (IPv6) address.
